(19) United States
(12) Patent Application Publication
(10) Pub. No.: US 2002/0077947 A1
(43) Pub. Date: Jun. 20, 2002

(54) Method and system for determining netted margins

(76) Inventors: David Charles Ward, Bromley (GB); Alan Spencer Milligan, London (GB)

Correspondence Address: STAAS & HALSEY LLP, 700 11TH STREET, NW, SUITE 500, WASHINGTON, DC, 20001, US

(21) Appl. No.: 09/735,794

(22) Filed: Dec. 14, 2000

(51) Int. Cl. G06F 17/60

(52) U.S. Cl. 705/36

(57) ABSTRACT

An electronic information processing repository which receives position information from clearing houses, determines netted margin and cover information using the position information for an entity, and provides the netted margin and cover information back to the clearing houses.

### BACKGROUND OF THE INVENTION

1. Field of the Invention

The present invention relates to exchanges and clearing houses. More particularly, the present invention relates to an electronic information processing repository which receives position information from members of clearing houses, determines netted margin and cover information using the position information, and provides the netted margin and cover information back to the exchange-owned and member-owned clearing houses.

2. Description of the Related Art

For decades, financial institutions have used central exchange-owned and member-owned clearing houses (hereinafter referred to as “clearers”) to execute and settle trades and positions with other financial institutions. The central exchanges facilitate a transparent market, and the clearers provide guarantees of payment should a member financial institution default on a required payment. In order to guarantee payment, clearers measure the risk associated with each member's position in the market and associate a cost with the measured risk. This cost, or risk premium, is translated into daily margin calls for each and every member. Margin calls are settled by a member via a combination of cash and collateral (e.g., treasury bonds and bills).

A problem arises when a financial institution is a member of several clearers. In the course of business, on a given day, a financial institution may have a position with one exchange that is the opposite of a position with another exchange. Financially, these positions cancel one another out, resulting in no, or significantly less, net exposure or market risk. Hence, a much smaller risk premium should be charged to the financial institution. However, each clearer involved does not take this holistic view, and most if not all clearers offer margin offsetting on a per member account basis only.

As an example, assume that Bank-A has a 10 Long EuroBond futures position with the Chicago Board of Trade (CBOT), and Bank-A has a 10 Short EuroBond futures position with the London Clearing House (LCH). Currently, Bank-A will be charged initial margin on the 10 Long position by the clearer used by the CBOT, and it will be charged initial margin for the 10 Short position by the clearer used by the LCH, even though the net position (excluding fx risk, basis risk, etc.) is zero. Therefore, Bank-A is paying substantially more margin as it should be paying: one margin payment to the CBOT clearer, and another margin payment to the LCH clearer. Moreover, default funds, collateral, and membership fees must be put up for both clearers. These costs are intensified when a financial institution is a member of multiple exchanges.

As a further example, many members often have more than one account per clearer. For example, assume that Bank-A has a fixed income Business Unit (BU) owning an account with a clearer, and Bank-A has an interest rate derivatives BU owning another, separate account with the same clearer. If Bank-A's fixed income BU has a 10 Long June 2000 Treasury futures position, and Bank-A's interest rate derivatives BU has a 10 Short June 2000 Treasury futures position, the clearer will calculate margin for each long and short position, respectively, because each BU has its own, separate account with the clearer. In addition, initial margin, default funds, and collateral must be put up for both accounts. Ideally, it would be beneficial for Bank-A if its net position with the clearer could be margined, as there would be a substantial savings for Bank-A.

FIG. 1 shows prior art transactions that take place between a financial institution and the separate exchanges and clearers that the financial institution trades with. According to the prior art, financial institution 1 executes trades with exchange 3 via datalink 35. Exchange 3 sends trading information of its trades with financial institution 1 to clearer 5 via datalink 40. Typically at the end of the trading day, clearer 5 calculates margin for financial institution 1 based upon the trading information received from exchange 3, as is well known in the art. Financial institution 1 is then charged by clearer 5 based upon the margin call amount calculated by clearer 5 via datalink 45, and the account of financial institution 1 will be debited by clearer 5 via datalink 50 based upon the margin call.

Financial institution 1 may also execute trades with exchange 7, which is separate and independent from exchange 3, via datalink 55. Exchange 7 sends trading information of its trades with financial institution 1 to clearer 20 via datalink 60. Typically at the end of the trading day, clearer 20 calculates margin for financial institution 1 based upon the trading information received from exchange 7, as is well known in the art. Financial institution 1 is then charged based upon the margin call amount calculated by clearer 20 via datalink 65, and the account of financial institution 1 will be debited by clearer 20 via datalink 70 based upon the margin call. However, as described above, financial institution 1 may have a position with exchange 3 that cancels out its position with exchange 7, resulting in a zero margin, even though it is charged twice according to the prior art: once based upon the margin calculated by clearer 5, and again based upon the margin calculated by clearer 20.

Therefore, a need exists for a system and method that receives position information from one or more clearers, so that if a financial institution has a position with one exchange that cancels out or decreases a position with another exchange, the financial institution will only be charged for the net (total) position.

### SUMMARY OF THE INVENTION

It is an object of the present invention to provide a centralized virtual clearing service.

Another object of the present invention is to allow members of existing financial exchanges to gain financial advantage by netting-out equivalent but opposite positions across two or more exchanges.

A further object of the present invention is to allow members of existing financial exchanges to gain financial advantage by determining net margin for equivalent, non-opposite positions across two or more exchanges.

Yet another object of the present invention to is reduce position settlement time and cost by generating and providing a single position statement to a financial institution which is created by aggregating the costs of all positions owned across one or more of the exchanges used by the financial institution.

The above objects can be attained by a system and method that determines netted margin positions by receiving position information from a plurality of clearers, by determining a netted margin position and a cover for an entity, based upon the position information, and by providing the netted margin information and cover to the plurality of clearers.

These together with other objects and advantages which will be subsequently apparent, reside in the details of construction and operation as more fully hereinafter described and claimed, reference being had to the accompanying drawings forming a part hereof.

### BRIEF DESCRIPTION OF THE DRAWINGS

FIG. 1 shows prior art transactions that take place between a financial institution and the separate exchanges and clearers that the financial institution interacts with.

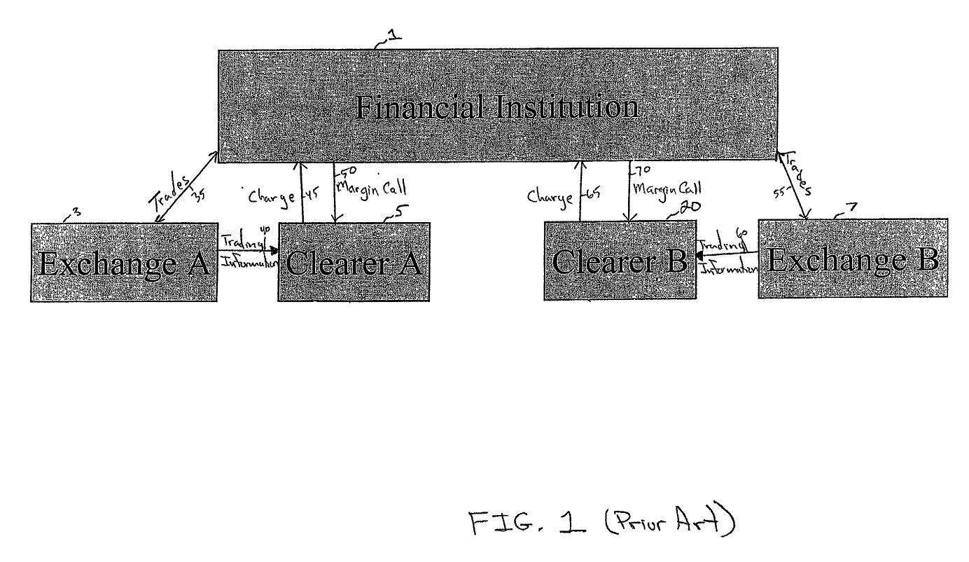

FIG. 2 shows a virtual clearing service without margin distribution according to an embodiment of the present invention.

FIG. 3 shows a virtual clearing service with margin distribution using the Net Member Payment option according to an embodiment of the present invention.

FIG. 4 shows a virtual clearing service with margin distribution using the SVC Rebate option according to an embodiment of the present invention.

FIG. 5 shows a virtual clearing service with margin distribution using the Clearer Rebate option according to an embodiment of the present invention.

FIG. 6 shows a virtual clearing service with margin distribution using the Clearer Rebate Margin Call option according to an embodiment of the present invention.

### DESCRIPTION OF THE PREFERRED EMBODIMENTS

Before discussing the features of the present invention, a summary of the terms used in the discussion herein will be provided.

A futures contract is a legally binding agreement, made on the trading floor of a futures exchange, to buy or sell a commodity or security sometime in the future. Futures contracts are standardized according to the quality, quantity, and delivery time and location for each commodity. The only variable is price, which is discovered on an exchange trading floor.

Initial margin is the initial amount futures market participants must have in their bank accounts to protect against the possible market risk losses incurred in closing out a defaulting member's futures market account.

Variation Margin is additional margin paid or received by a clearing member firm to a clearer in order to bring the equity in an account back up to the initial margin level. Variation margin is calculated on a day-to-day basis.

A default fund protects against the possible credit risk losses incurred in extreme market situations where one or more members default and the loss is greater than the sum of the variation margin and the initial margin.

A clearing house is an agency or separate corporation of a futures exchange that guarantees to its members the financial performance of all contracts traded on the exchange. A clearing house is responsible for settling trading accounts, clearing trades, collecting and maintaining margin monies, regulating delivery, and reporting trading data. Clearing houses act as third parties to all futures and options contracts, acting as a buyer to every clearing member seller and a seller to every clearing member buyer.

An exchange is a formal (rule based) physical or virtual place for the selling and buying of securities and the provision of a mechanism to set prices.

A security is any note, stock, treasury stock, bond, debenture, certificate of interest or participation in any profit-sharing agreement or in any oil, gas, or other mineral royalty or lease, any collateral trust certificate, preorganization certificate or subscription, transferable share, investment contract, voting-trust certificate, certificate of deposit, for a security, any put, call, straddle, option, or privilege on any security, certificate of deposit, or group or index of securities (including any interest therein or based on the value thereof), or any put, call, straddle, option, or privilege entered into on a national securities exchange relating to foreign currency, or in general, any instrument commonly known as a ‘security’; or any certificate of interest or participation in, temporary or interim certificate for, receipt for, or warrant or right to subscribe to or purchase, any of the foregoing; but does not include currency or any note, draft, bill of exchange, or banker's acceptance which has a maturity at the time of issuance of not exceeding nine months, exclusive of days of grace, or any renewal thereof the maturity of which is likewise limited.

A position is the amount of a security either owned (a long position) or owed (a short position) by an investor or dealer.

An offset is a second futures or options position opposite to the initial or opening position.

Gross margin is the margin cost to a financial institution using one or more clearers without the benefit of the present invention.

Net margin is the netted amount of all positions from one or more clearers used by a given financial institution.

Cover is the shortfall or difference between the gross margin and the net margin.

Margin distribution includes various mechanisms for delivering netted margin positions back to the member firms.

Reference will now be made in detail to the preferred embodiments of the present invention, examples of which are illustrated in the accompanying drawings, wherein like reference numerals refer to like elements throughout.

In order to eliminate the unnecessary excess charges to financial institution 1 outlined above, a centralized virtual clearing service is needed that allows members of existing financial exchanges to gain financial advantage by netting-out equivalent but opposite positions across two or more exchanges, and by using modern portfolio theory, which is well known in the art, to determine the net margin for positions across two or more exchanges which are equivalent but not opposite.

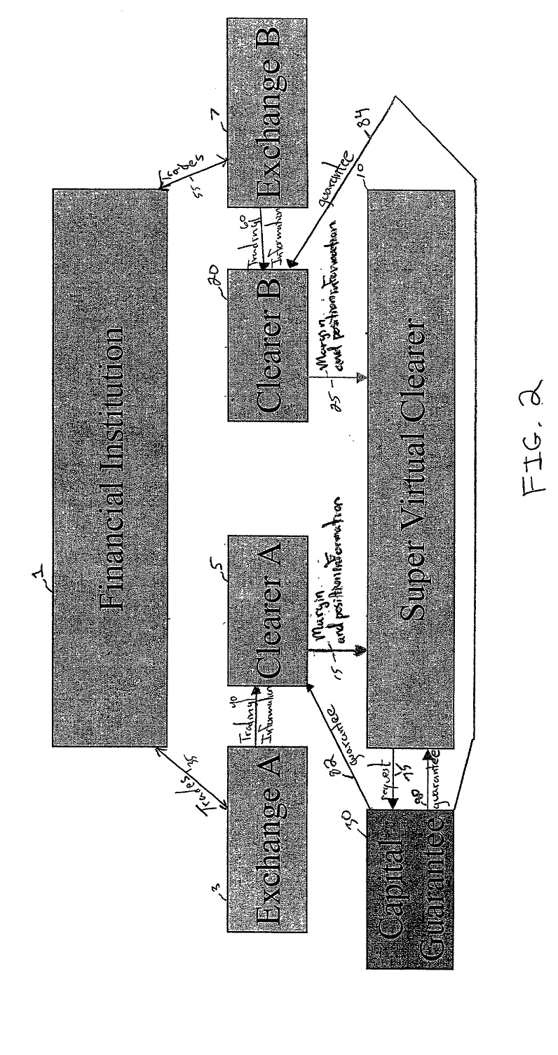

Such a virtual clearing service is enabled by super virtual clearer (SVC) 10, as shown in FIGS. 2-6. SVC 10 advantageously adopts a sophisticated approach to assessing risk, based on models and techniques already in use within the finance industry & accepted by G10 Regulators. SVC 10 further provides mechanisms for receiving position information from clearers, calculates and delivers netted margin positions to the clearers, provides to clearing houses and member firms payment information to reconcile the determined net margin, and requests a capital guarantee and provides a cover to clearing houses for the shortfall between the gross margin and the determined net margin.

FIG. 2 shows a virtual clearing service without margin distribution according to an embodiment of the present invention. As shown in FIG. 2, financial institution 1 executes trades with exchange 3 via datalink 35. Financial institution 1 may be a single financial institution, or it may be a top level holding company comprising of different subsidiaries which are members of exchanges 3 and 7, and members of clearers 5 and 20. Exchange 3 sends trading information of its trades with financial institution 1 to clearer 5 via datalink 40. Typically at the end of the trading day, clearer 5 calculates margin for financial institution 1 based upon the trading information received from exchange 3.

Financial institution 1 may also execute trades with exchange 7, which is separate and independent from exchange 3, via datalink 55. Exchange 7 sends trading information of its trades with financial institution 1 to clearer 20 via datalink 60. Typically at the end of the trading day, clearer 20 calculates margin for financial institution 1 based upon the trading information received from exchange 7.

Clearer 5 next transmits the margin and position information based upon the trades executed by financial institution 1 with exchange 3 to SVC 10 via datalink 15. Either simultaneously, previous, or subsequent thereto, clearer 20 transmits the margin and position information based upon the trades executed by financial institution 1 with exchange 7 to SVC 10 via datalink 25. The datalinks 15, 25, 35, 40, 55, 60, 75, 80, 85, 90, 100, 105, 110, 115, 120, 125, 130, 135, 140, 145, 150, 155, and 160 may be any type of communication link or line which has the ability to transmit information, such as an analog telephone line, a digital fiber-optic line, a wireless transmission, or any other type of communications link.

SVC 10, using the received position information from clearer 5 and from clearer 20, next calculates, without human processing, net margin by netting out all of the like contracts owned by financial institution 1 across all of the different geographies and products (e.g. securities), so that, for example, two products that are the same but with opposite positions, the net margin charge will net out to zero.

For products that are the same, but which have positions which are not opposite, SVC 10 uses modern portfolio theory in calculating net margin to offer savings to financial institution 1 which would otherwise not be realized by existing clearers without the benefit of SVC 10. For example, conventional clearers use a mark-to-market or mark-to-model approach for the calculation of margin. Co-variance characteristics between assets or instruments are not typically examined in any quantitative sense and in most cases the co-variance or correlation between assets is assumed to be near 1. This often results in a significant over-charging of margin to the members. As an illustration, assume that Financial Institution 1 has a fixed income account with a 10 Long December 2000 position in Treasury Bond Futures with Exchange 3 and a 20 Short December 2000 position in German Euro-Bund Futures with exchange 7. Even though the Correlation between the positions is significantly less than 1, and a savings is possible due to the diversification of non-systemic risk, this savings is not passed along to the members by existing clearers, such as clearer 5 and clearer 20. On large accounts, or portfolios, this saving due to diversification and subsequent reduction of nonsystemic risk is often substantial to members.

SVC 10 next calculates a cover rebate amount for financial institution 1 by subtracting the net margin from a calculated gross margin, where SVC 10 calculates the gross margin by summing up the margin charges determined by clearers 5 and 20 and sent to SVC 10, as described above.

SVC 10 requests a guarantee for the determined cover amount from capital guarantee 30 via datalink 75. Capital guarantee 30 underwrites the risk-of-loss between clearers 5 and 20 calculated margins and the calculated net margins of SVC 10 for each clearer. This may be done in the form of selling on the risk to a consortium of insurers and passing this as a guarantee along to clearers 5 and 20. This guarantee may be stated and agreed in either a Master Agreement or performed on a member-by-member account basis at the end of each day. If approved, capital guarantee 30 sends its guarantee for the cover calculated and requested by SVC 10 to SVC 10 via datalink 80, or, alternately, capital guarantee 30 sends its guarantee for the cover calculated and requested by SVC 10 directly to clearers 5 and 20 via datalinks 82 and 84, respectively. Capital guarantee 30 may send its guarantee for every transaction, or alternately, capital guarantee 30 may send its guarantee for all cover amounts within a certain risk level.

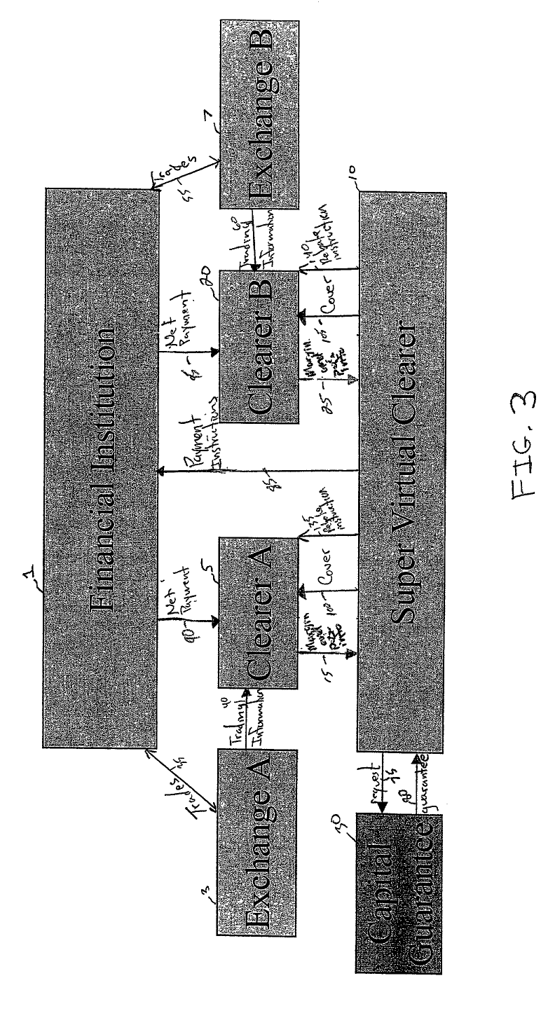

FIGS. 3-6 show different options for delivering the savings (or cover amount) resulting from using SVC 10 back to financial institution 1. FIG. 3 shows a virtual clearing service with margin distribution using the Net Member Payment option according to an embodiment of the present invention. As shown in FIG. 3, financial institution 1 executes trades with exchange 3 via datalink 35. Exchange 3 sends trading information of its trades with financial institution 1 to clearer 5 via datalink 40. Typically at the end of the trading day, clearer 5 calculates margin for financial institution 1 based upon the trading information received from exchange 3.

Financial institution 1 may also execute trades with exchange 7, which is separate and independent from exchange 3, via datalink 55. Exchange 7 sends trading information of its trades with financial institution 1 to clearer 20 via datalink 60. Typically at the end of the trading day, clearer 20 calculates margin for financial institution 1 based upon the trading information received from exchange 7.

Clearer 5 next transmits the margin and position information based upon the trades executed by financial institution 1 with exchange 3 to super virtual clearer (SVC) 10 via datalink 15. Either simultaneously, previous, or subsequent thereto, clearer 20 transmits the margin and position information based upon the trades executed by financial institution 1 with exchange 7 to SVC 10 via datalink 25.

SVC 10, using the received position information from clearer 5 and from clearer 20, next calculates, without human processing, net margin by netting out all of the like contracts owned by financial institution 1 across all of the different geographies and products (e.g. securities), so that, for example, two products that are the same but with opposite positions, the net margin charge will net out to zero.

SVC 10 next calculates a cover rebate amount for financial institution 1 by subtracting the net margin from a calculated gross margin, where SVC 10 calculates the gross margin by summing up the margin charges determined by clearers 5 and 20 and sent to SVC 10.

SVC 10 requests a guarantee for the determined cover amount from capital guarantee 30 via datalink 75. If approved, capital guarantee 30 sends its guarantee for the cover calculated and requested by SVC 10 to SVC 10 via datalink 80.

SVC 10 next sends a rebate instruction to clearers 5 and 20 via datalinks 135 and 140, respectively, describing the cover rebate, or reimbursement, financial institution 1 should receive based upon the re-calculated market and credit risk (i.e., amount of the rebate is equal to the calculated cover amount determined by SVC 10, as described above).

Financial institution 1 next pays only the calculated net margin amount to clearer 5 and to 20, as opposed to paying a combined sum to clearers 5 and 20 equal to the gross margin. This is achieved by SVC 10 first sending payment instructions to financial institution 1 via datalink 85. The payment instructions, which may take the form of a billing statement, instruct financial institution 1 of the amount of a net margin payment which should be paid to clearer 5 and to clearer 20, based upon the net margin calculation preformed by SVC 10, as described above. Next, financial institution 1 sends the instructed net margin payments to clearers 5 and 20, via datalinks 90 and 95, respectively. Due to the fact that the net margin payment received by clearers 5 and 20 is in most instances less than the gross margin, SVC 10 additionally sends a cover amount or a guarantee for the cover amount received by capital guarantee 30 to both clearers 5 and 20, via datalinks 100 and 105, respectively.

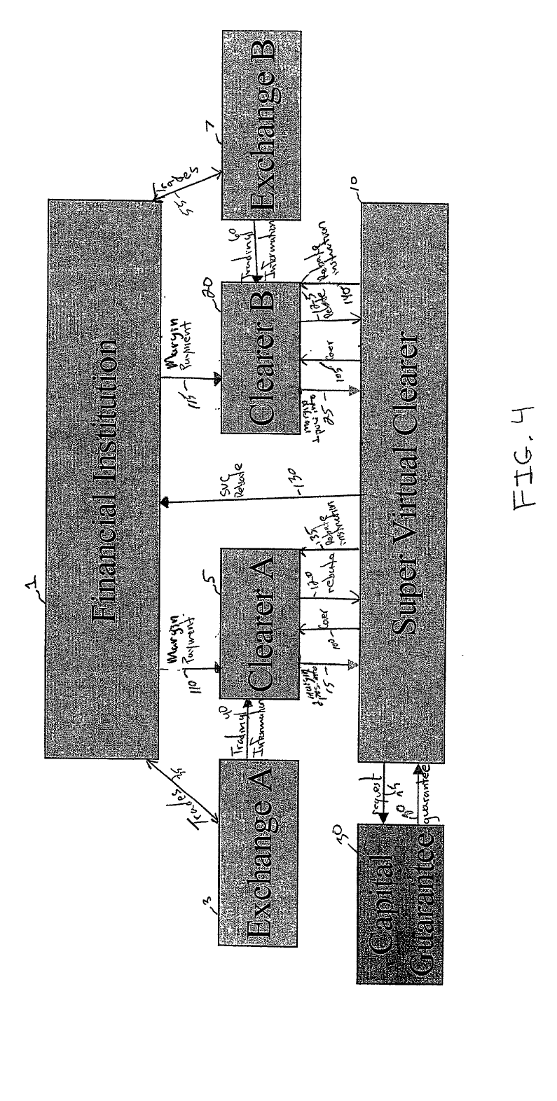

FIG. 4 shows a virtual clearing service with margin distribution using the SVC Rebate option according to an embodiment of the present invention. As shown in FIG. 4, financial institution 1 executes trades with exchange 3 via datalink 35. Exchange 3 sends trading information of its trades with financial institution 1 to clearer 5 via datalink 40. Typically at the end of the trading day, clearer 5 calculates margin for financial institution 1 based upon the trading information received from exchange 3.

Financial institution 1 may also execute trades with exchange 7, which is separate and independent from exchange 3, via datalink 55. Exchange 7 sends trading information of its trades with financial institution 1 to clearer 20 via datalink 60. Typically at the end of the trading day, clearer 20 calculates margin for financial institution 1 based upon the trading information received from exchange 7.

Clearer 5 next transmits the margin and position information based upon the trades executed by financial institution 1 with exchange 3 to super virtual clearer (SVC) 10 via datalink 15. Either simultaneously, previous, or subsequent thereto, clearer 20 transmits the margin and position information based upon the trades executed by financial institution 1 with exchange 7 to SVC 10 via datalink 25.

SVC 10, using the received position information from clearer 5 and from clearer 20, next calculates, without human processing, net margin by netting out all of the like contracts owned by financial institution 1 across all of the different geographies and products (e.g. securities), so that, for example, two products that are the same but with opposite positions, the net margin charge will net out to zero.

SVC 10 next calculates a cover rebate amount for financial institution 1 by subtracting the net margin from a calculated gross margin, where SVC 10 calculates the gross margin by summing up the margin charges determined by clearers 5 and 20 and sent to SVC 10, as described above.

SVC 10 requests a guarantee for the determined cover amount from capital guarantee 30 via datalink 75. If approved, capital guarantee 30 sends its guarantee for the cover calculated and requested by SVC 10 to SVC 10 via datalink 80.

SVC 10 next sends a rebate instruction to clearers 5 and 20 via datalinks 135 and 140, respectively, describing the cover rebate, or reimbursement, financial institution 1 should receive based upon the re-calculated market and credit risk (i.e., amount of the rebate is equal to the calculated cover amount determined by SVC 10, as described above).

Financial institution 1 next pays a total amount equal to the gross margin to clearers 5 and 20, via datalinks 110 and 115, respectively. The amount received by each clearer is equal to the margins independently determined by clearers 5 and 20, as described above, i.e., the gross margin equals the sum of the margins determined by clearers 5 and 20.

Alternately, clearer 5 may be authorized to deduct a payment amount equal to the determined margin amount charged by clearer 5 directly from financial institution 1 via datalink 110, and clearer 20 may be authorized to deduct an amount equal to the determined margin amount charged by clearer 20 directly from Financial institution 1 via datalink 115.

Clearers 5 and 20 send SVC 10 a monetary rebate, via datalinks 120 and 125, respectively, each rebate equal in amount to the determined cover amount, and SVC next sends the rebate to Financial institution 1 via datalink 130. Due to the fact that the margin payments received by clearers 5 and 20 minus the rebate sent from clearers 5 and 20 is in most instances less than the gross margin, SVC 10 additionally sends a cover amount or a guarantee for the cover amount received by capital guarantee 30 to both clearers 5 and 20 via datalinks 100 and 105, respectively.

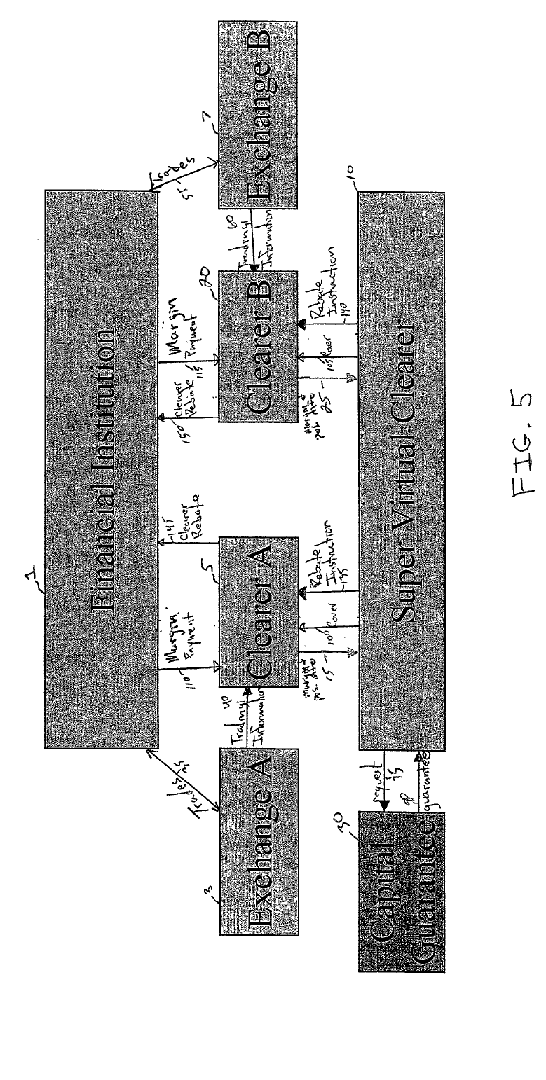

FIG. 5 shows a virtual clearing service with margin distribution using the Clearer Rebate option according to an embodiment of the present invention. As shown in FIG. 5, financial institution 1 executes trades with exchange 3 via datalink 35. Exchange 3 sends trading information of its trades with financial institution 1 to clearer 5 via datalink 40. Typically at the end of the trading day, clearer 5 calculates margin for financial institution 1 based upon the trading information received from exchange 3.

Financial institution 1 may also execute trades with exchange 7, which is separate and independent from exchange 3, via datalink 55. Exchange 7 sends trading information of its trades with financial institution 1 to clearer 20 via datalink 60. Typically at the end of the trading day, clearer 20 calculates margin for financial institution 1 based upon the trading information received from exchange 7.

Clearer 5 next transmits the margin and position information based upon the trades executed by financial institution 1 with exchange 3 to super virtual clearer (SVC) 10 via datalink 15. Either simultaneously, previous, or subsequent thereto, clearer 20 transmits the margin and position information based upon the trades executed by financial institution 1 with exchange 7 to SVC 10 via datalink 25.

SVC 10, using the received position information from clearer 5 and from clearer 20, next calculates, without human processing, net margin by netting out all of the like contracts owned by financial institution 1 across all of the different geographies and products (e.g. securities), so that, for example, two products that are the same but with opposite positions, the net margin charge will net out to zero.

SVC 10 next calculates a cover rebate amount for financial institution 1 by subtracting the net margin from a calculated gross margin, where SVC 10 calculates the gross margin by summing up the margin charges determined by clearers 5 and 20 and sent to SVC 10.

SVC 10 requests a guarantee for the determined cover amount from capital guarantee 30 via datalink 75. If approved, capital guarantee 30 sends its guarantee for the cover calculated and requested by SVC 10 to SVC 10 via datalink 80.

SVC 10 next sends a rebate instruction to clearers 5 and 20 via datalinks 135 and 140, respectively, describing the cover rebate, or reimbursement, financial institution 1 should receive based upon the re-calculated market and credit risk (i.e., amount of the rebate is equal to the calculated cover amount determined by SVC 10, as described above). Next, financial institution 1 pays a total amount equal to the gross margin to clearers 5 and 20 via datalinks 110 and 115, respectively. The amount received by each clearer is equal to the margins independently determined by clearers 5 and 20, as described above, i.e., the gross margin equals the sum of the margins determined by clearers 5 and 20. After receiving the margin payments, clearers 5 and 20 send a rebate in the amount specified by the rebate instruction to financial institution 1, via datalinks 145 and 150, respectively. Due to the fact that the gross margin payment received by clearers 5 and 20 minus the rebate sent from clearers 5 and 20 is in most instances less than the gross margin, SVC 10 additionally sends a cover amount or a guarantee for the cover amount received by capital guarantee 30 to clearers 5 and 20 via datalinks 100 and 105, respectively.

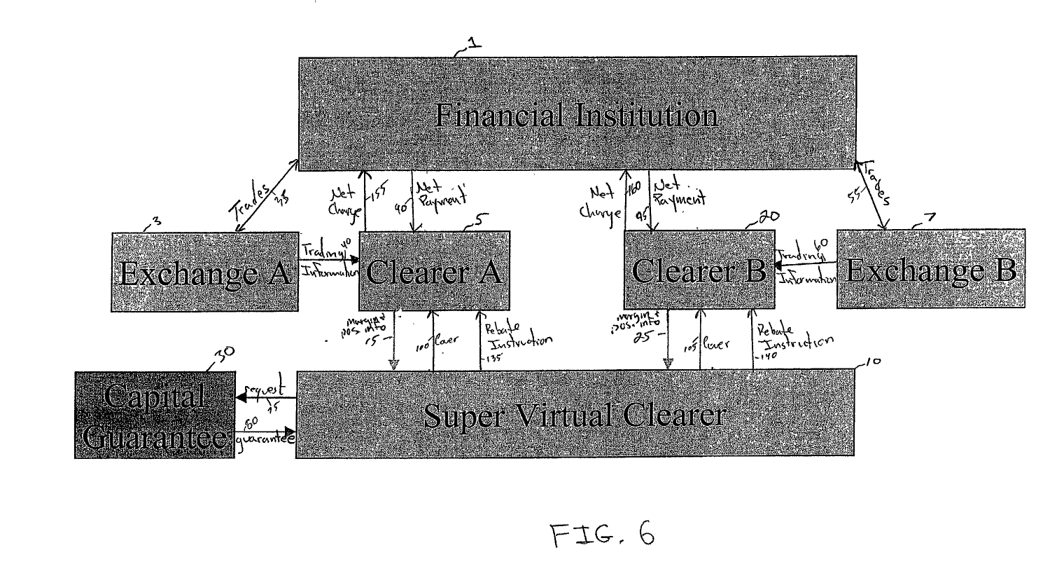

FIG. 6 shows a virtual clearing service with margin distribution using the Clearer Rebate Margin Call option according to an embodiment of the present invention. As shown in FIG. 6, financial institution 1 executes trades with exchange 3 via datalink 35. Exchange 3 sends trading information of its trades with financial institution 1 to clearer 5 via datalink 40. Typically at the end of the trading day, clearer 5 calculates margin for financial institution 1 based upon the trading information received from exchange 3.

Financial institution 1 may also execute trades with exchange 7, which is separate and independent from exchange 3, via datalink 55. Exchange 7 sends trading information of its trades with financial institution 1 to clearer 20 via datalink 60. Typically at the end of the trading day, clearer 20 calculates margin for financial institution 1 based upon the trading information received from exchange 7, as is well known in the art.

Clearer 5 next transmits the margin and position information based upon the trades executed by financial institution 1 with exchange 3 to SVC 10 via datalink 15. Either simultaneously, previous, or subsequent thereto, clearer 20 transmits the margin and position information based upon the trades executed by financial institution 1 with exchange 7 to SVC 10 via datalink 25.

SVC 10, using the received position information from clearer 5 and from clearer 20, next calculates, without human processing, net margin for each of clearers 5 and 20 by netting out all of the like contracts owned by financial institution 1 across all of the different geographies and products (e.g. securities), so that, for example, two products that are the same but with opposite positions, the net margin charge will net out to zero.

SVC 10 next calculates a cover rebate amount for financial institution 1 by subtracting the net margin from a calculated gross margin, where SVC 10 calculates the gross margin by summing up the margin charges determined by clearers 5 and 20 and sent to SVC 10.

SVC 10 requests a guarantee for the determined cover amount from capital guarantee 30 via datalink 75. If approved, capital guarantee 30 sends its guarantee for the cover calculated and requested by SVC 10 to SVC 10 via datalink 80.

SVC 10 next sends a rebate instruction to each of clearers 5 and 20, via datalinks 135 and 140, respectively. The rebate instruction informs clearers 5 and 20 how much of a rebate financial institution 1 should receive from each individual clearer. A rebate amount is contained within the rebate instruction, which is equal to the cover amounts determined by SVC 10, as described above. In order for clearers 5 and 20 to grant the rebate to financial institution 1, clearers 5 and 20 deduct their separate rebate amounts from the clearers' separately calculated margins, and then clearers 5 and 20 send a request for payment to financial institution 1, via datalinks 155 and 160, respectively, which equals the net margin amount for each respective clearer. Financial institution 1 next sends a payment amount equal to the net margin amount charged by clearer 5 to clearer 5 via datalink 90, and Financial institution 1 sends a payment amount equal to the net margin amount charged by clearer 20 to clearer 20 via datalink 95.

Alternately, clearer 5 may be authorized to deduct a payment amount equal to the net margin amount by clearer 5 directly from financial institution 1 via datalink 90, and clearer 20 may be authorized to deduct an amount equal to the net margin amount charged by clearer 20 directly from Financial institution 1 via datalink 95.

Due to the fact that the net margin payment received by clearers 5 and 20 is in most instances less than their calculated gross margins, SVC 10 additionally sends a cover amount or a guarantee for the cover amount received by capital guarantee 30 to both clearers 5 and 20.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for determining netted margin positions, comprising:
inputting position information from a plurality of clearers;
determining a netted margin position and a cover for an entity, based upon said position information; and
outputting the netted margin information and the cover to the plurality of clearers.

2. The method for determining netted margin positions according to claim 1, wherein determining the netted margin position is performed using portfolio analysis.

3. The method for determining netted margin positions according to claim 1, wherein determining the netted margin position is performed by netting-out equivalent but opposite inputted positions.

4. The method for determining netted margin positions according to claim 1, further comprising:
inputting margin information from a plurality of clearers; and
determining a gross margin based upon the inputted margin information.

5. The method for determining netted margin positions according to claim 1, further comprising:
determining margin charges for the plurality of clearers based upon the inputted position information; and
determining a gross margin based upon the margin charges.

6. The method for determining netted margin positions according to claim 5, further comprising:
securing a capital guarantee for the difference between the gross margin and the determined netted margin.

7. The method for determining netted margin positions according to claim 4, wherein determining the cover is performed by calculating the difference between the netted margin positions and the gross margin.

8. The method for determining netted margin positions according to claim 1, wherein the entity is a financial institution.

9. A method for determining netted margin positions, comprising:
inputting position information from a plurality of clearers;
determining a netted margin position and a cover for an entity, based upon said position and margin information; and
outputting payment instructions to the entity based upon the netted margin information, and outputting the cover to the plurality of clearers.

10. The method for determining netted margin positions according to claim 9, wherein the entity makes payments to the plurality of clearers based upon the payment instructions.

11. The method for determining netted margin positions according to claim 9, wherein determining the netted margin position is performed using portfolio analysis.

12. The method for determining netted margin positions according to claim 9, wherein determining the netted margin position is performed by netting-out equivalent but opposite inputted positions.

13. The method for determining netted margin positions according to claim 9, further comprising:
inputting margin information from a plurality of clearers; and
determining a gross margin based upon the inputted margin information.

14. The method for determining netted margin positions according to claim 13, further comprising:
securing a capital guarantee for the difference between the gross margin and the determined netted margin.

15. The method for determining netted margin positions according to claim 9, further comprising:
determining margin charges for the plurality of clearers based upon the inputted position information; and
determining a gross margin based upon the margin charges.

16. The method for determining netted margin positions according to claim 13, wherein determining the cover is performed by calculating the difference between the netted margin positions and the gross margin.

17. The method for determining netted margin positions according to claim 9, wherein the entity is a financial institution.

18. A method for determining netted margin positions, comprising:
inputting position information from a plurality of clearers;
determining a netted margin position and a cover for an entity, based upon said position and margin information; and
outputting a rebate to the entity based upon the netted margin information, and outputting the cover to the plurality of clearers.

19. The method for determining netted margin positions according to claim 18, further comprising:
inputting a plurality of rebates from the plurality of clearers.

20. The method for determining netted margin positions according to claim 18, wherein determining the netted margin position is performed using portfolio analysis.

21. The method for determining netted margin positions according to claim 18, wherein determining the netted margin position is performed by netting-out equivalent but opposite inputted positions.

22. The method for determining netted margin positions according to claim 18, further comprising:
inputting margin information from a plurality of clearers; and
determining a gross margin based upon the inputted margin information.

23. The method for determining netted margin positions according to claim 18, further comprising:
securing a capital guarantee for the difference between the gross margin and the determined netted margin.

24. The method for determining netted margin positions according to claim 18, further comprising:
determining margin charges for the plurality of clearers based upon the inputted position information; and
determining a gross margin based upon the margin charges.

25. The method for determining netted margin positions according to claim 22, wherein determining the cover is performed by calculating the difference between the netted margin positions and the gross margin.

26. The method for determining netted margin positions according to claim 18, wherein the entity is a financial institution.

27. A method for determining netted margin positions, comprising:
inputting position information from a plurality of clearers;
determining a netted margin position and a cover for an entity, based upon said position and margin information; and
outputting rebate instructions and the cover to the plurality of clearers based upon the netted margin information.

28. The method of determining netted margin positions according to claim 27, wherein the plurality of clearers send rebates to the entity based upon the rebate instructions.

29. The method for determining netted margin positions according to claim 27, wherein determining the netted margin position is performed using portfolio analysis.

30. The method for determining netted margin positions according to claim 27, wherein determining the netted margin position is performed by netting-out equivalent but opposite inputted positions.

31. The method for determining netted margin positions according to claim 27, further comprising:
inputting margin information from a plurality of clearers; and
determining a gross margin based upon the inputted margin information

32. The method for determining netted margin positions according to claim 31, further comprising:
securing a capital guarantee for the difference between the gross margin and the determined netted margin.

33. The method for determining netted margin positions according to claim 27, further comprising:
determining margin charges for the plurality of clearers based upon the inputted position information; and
determining a gross margin based upon the margin charges.

34. The method for determining netted margin positions according to claim 31, wherein determining the cover is performed by calculating the difference between the netted margin positions and the gross margin.

35. The method for determining netted margin positions according to claim 27, wherein the entity is a financial institution.

36. A method for determining netted margin positions, comprising:
inputting position information from a plurality of clearers;
determining a netted margin cost for an entity, based upon said position information;
generating a statement with the netted margin cost; and
sending the statement to the entity.

37. The method for determining netted margin positions according to claim 36, wherein the entity is a financial institution.

38. The method for determining netted margin positions according to claim 36, wherein the determining a netted margin cost is facilitated by netting-out equivalent but opposite inputted position information.
